(19) United States
(12) Patent Application Publication
(10) Pub. No.: US 2026/0002548 A1
(43) Pub. Date: Jan. 1, 2026

(54) MOTOR SUPPORT AND MOTORISED FAN UNIT FOR A HEATING, VENTILATION AND/OR AIR-CONDITIONING SYSTEM OF A CORRESPONDING VEHICLE, IN PARTICULAR A MOTOR VEHICLE

(71) Applicant: VALEO SYSTEMES THERMIQUES, Le Mesnil-Saint-Denis (FR)

(72) Inventors: Elmehdi Bensaih, Le Mesnil-Saint-Denis (FR); Frederic Moulinas, Le Mesnil-Saint-Denis (FR); Radek Lohonka, Prague (CZ)

(73) Assignee: VALEO SYSTEMES THERMIQUES, Le Mesnil-Saint-Denis (FR)

(21) Appl. No.: 19/107,220

(22) PCT Filed: Aug. 24, 2023
(86) PCT No.: PCT/EP2023/073201

§ 371 Date: Feb. 27, 2025

(30) Foreign Application Priority Data
Aug. 29, 2022 (FR) FR2208598

(51) Int. Cl. F04D 29/60; B60H 1/24; F04D 25/06; F04D 25/08

(52) U.S. Cl. CPC F04D 29/601; B60H 1/24; F04D 25/06; F04D 25/08

(57) ABSTRACT

A motor support for a motor for driving a fan impeller of a motorized fan unit for a heating, ventilation and/or air-conditioning system of a motor vehicle is disclosed herein. The motor support includes a base having an internal structure and defining a cooling channel around the internal structure, in which channel an air flow is intended to circulate. The cooling channel includes at least one air inlet and at least one air outlet. The internal structure has a protrusion which is arranged facing the air inlet, the protrusion extending from the internal structure towards the air inlet so as to divide the air flow which is intended to come from the air inlet and circulate in the cooling channel.

The present invention relates to the field of heating, ventilation and/or air-conditioning systems for vehicles, in particular motor vehicles. The invention more particularly concerns a motor support for a fan impeller, in particular of a motorized fan unit. The invention also concerns a motorized fan unit for a heating, ventilation and/or air-conditioning system comprising such a motor support.

Vehicles, in particular motor vehicles, are commonly equipped with a heating, ventilation and/or air-conditioning system which makes it possible to create an air flow in the passenger compartment. Such a system also makes it possible to manage the temperature and distribution of the air flow created within the passenger compartment. Such a heating, ventilation and/or air-conditioning system comprises, inter alia, a fan comprising a fan impeller driven in rotation by a drive motor, notably an electric motor. The electric motor may in particular be an electronically switched motor controlled by a control module.

An electronically switched electric motor, or brushless direct current motor, has a rotor and stator assembly, each of these components bearing electromagnetic elements, the interaction of which causes the movement of the rotor relative to the stator and hence the movement of the fan impeller.

The electric motor is installed in the heating, ventilation and/or air-conditioning system by means of a motor support, which comprises a base with an internal structure allowing the fastening of the electric motor, more precisely of the stator.

As the motor and the control module comprise components which heat up during use, it is consequently necessary to ensure the cooling of the motor and/or the control module.

To this end, it is known to use the air flow circulating inside the heating, ventilation and/or air-conditioning system. To do this, a part of the air flow created by the motorized fan unit is diverted and directed towards the motor support. Thus the base of the motor support comprises at least one cooling channel for conducting the diverted air flow. The cooling channel is generally shaped to guide the diverted air flow towards the motor or the control module.

Optimizing the cooling performance of the motor or control module, and improving the ventilation performance of the motorized fan unit, are constant objectives. Also, the design of the cooling channel must not hinder the simple mounting of the motorized fan unit.

The object of the present invention is to propose a motor support, in particular for a motorized fan unit for a heating, ventilation and/or air-conditioning system of a motor vehicle, which is simple to produce and optimizes the cooling performance. Another object of the present invention is to improve the overall ventilation performance.

To this end, the invention relates to a motor support for a motor for driving a fan impeller, in particular of a motorized fan unit for a heating, ventilation and/or air-conditioning system of a motor vehicle, the motor support comprising a base, wherein the base comprises an internal structure configured for fastening of the motor and defines a cooling channel around the internal structure, in which channel an air flow is intended to circulate for cooling the motor and/or a control module of the motor, which is intended to be fastened to the motor support, the cooling channel having at least one air inlet and at least one air outlet.

According to the invention, the internal structure has a protrusion which is arranged facing the air inlet, the protrusion extending from the internal structure towards the air inlet so as to divide the air flow which is intended to come from the air inlet and circulate in the cooling channel.

Such a base defines a specific air channel for the function of cooling the motor and/or the control module, and the protrusion makes it possible to split the air flow intended to circulate in this channel. This protrusion makes it possible to create turbulence and increase the speed of the air flow.

The motor support may also have one or more of the following features described below, considered separately or in combination.

The protrusion may have an evolute form.

For example, the protrusion has a form which tapers in the direction of the air inlet.

The protrusion may have an end which may be arranged facing a median or substantially median zone of the air inlet.

The protrusion may have two concave surfaces extending on either side of the end. The concavity of these surfaces is for example oriented towards the cooling channel. Such concave surfaces make it possible to reduce the speed of the incoming air flow, and guide the air flow towards the interior of the cooling channel without creating turbulence, thus facilitating the flowing of the air flow.

The base may have at least partly a form generated by revolution about an axis. The axis of the base is for example intended to coincide with the rotational axis of the motor in the assembled state of the motorized fan unit.

The protrusion may extend radially relative to the axis of the base.

The internal structure may have an annular form, and the protrusion may extend from an outer wall of the annular form.

The internal structure may be in the center or substantially in the center of the motor support.

The air inlet and the air outlet may be diametrically opposite one another.

According to another aspect, the cooling channel may have a depth along the axis of the base which decreases between the air inlet and the air outlet. This difference in depth makes it possible to create a venturi effect and improve the flow behavior of the air flow.

The depth of the cooling channel decreases continuously for example.

The base may have a bottom wall and a front wall which are opposite one another along the axis of the base. The bottom wall and the front wall may delimit the cooling channel.

The depth between the bottom wall and the front wall at the air inlet is greater than the depth at the air outlet. The bottom wall thus forms a plane which is inclined relative to the plane defined by the front wall.

According to another aspect of the invention, the base comprises at least one rib extending from a side of the base opposite the cooling channel and arranged at least partly facing the air outlet. This allows the air flow to be guided towards the motor and the fan impeller without creating turbulence.

According to a particular example, the base comprises a material bridge connecting the internal structure to the front wall. The rib may extend from the material bridge, in particular towards the motor, passing through the middle or substantially the middle of the air outlet, such that the cooling channel opens on either side of the rib.

The rib may have a tapering form.

The rib may have two concave surfaces extending on the sides and from an end, for example rounded, on the side opposite the material bridge.

According to another aspect of the invention, at least one orifice is provided in the bottom wall of the base.

The base may have at least one assembly element, such as a boss, extending from a bottom wall of the base.

At least one orifice may be arranged in a wall, for example the bottom wall, of the base.

At least one orifice may be arranged close to the assembly element.

For example, at least two orifices are provided on either side of an assembly element. The orifice or orifices close to an assembly element make it possible to limit the turbulence which may be created by these assembly elements.

The assembly elements and the associated orifices next to these assembly elements may be situated on the outer periphery of the cooling channel, i.e. opposite the internal structure.

At least one orifice may be provided in the wall, for example the bottom wall, of the base, close to the air outlet. The orifice is for example arranged at a distance of less than or equal to 20 mm from the air outlet. Such an orifice makes it possible to change and in particular reduce the speed of the air flow.

Also, the motor support may comprise a heat sink fastened to the base and extending facing the cooling channel.

The heat sink comprises for example a housing, extending from a first side of the heat sink, mounted in the internal structure of the base and configured to receive an element of the motor, and on a second side opposite the first side, a slot configured to receive the control module.

The invention also concerns a motorized fan unit for a heating, ventilation and/or air-conditioning system of a vehicle, in particular a motor vehicle, comprising a fan impeller, a motor for driving the fan impeller, and a motor support as defined above.

The drive motor is for example a brushless motor.

Further advantages and features of the invention will become more clearly apparent on reading the following description, which is given by way of illustrative and non-limiting example, and the appended drawings, in which:

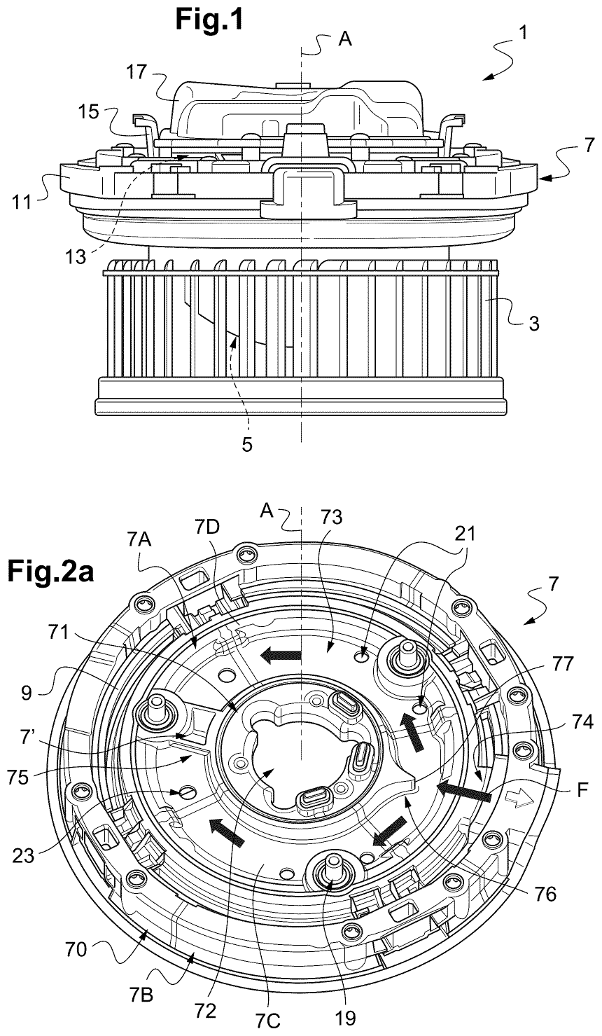

FIG. 1 shows an exemplary embodiment of a motorized fan unit according to the invention.

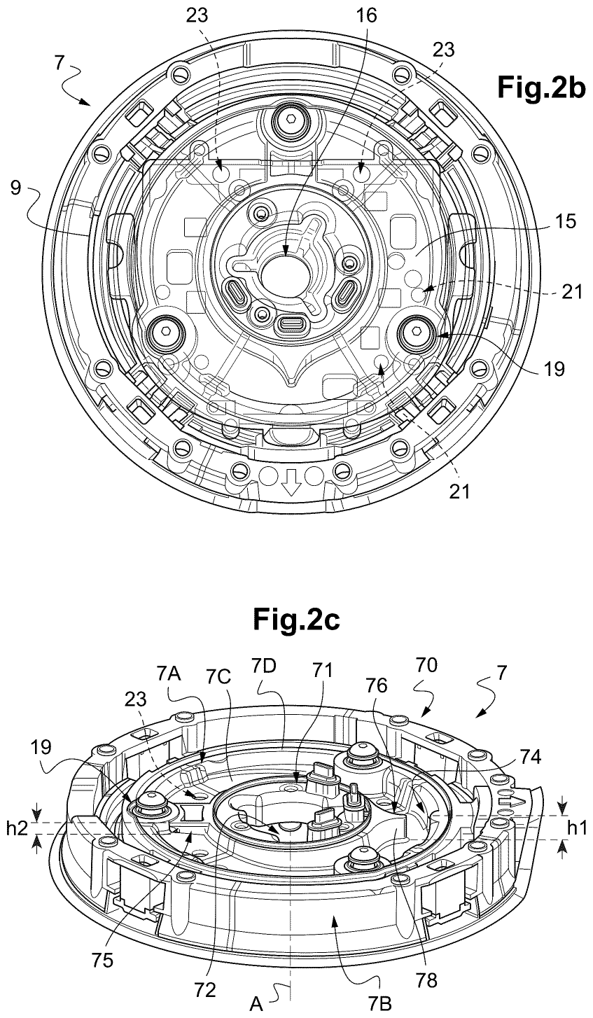

FIG. 2a is a perspective view of a base of the motor support of the motorized fan unit in FIG. 1.

FIG. 2b shows the base from FIG. 2a, on which a heat sink is fastened which is intended to carry a control module.

FIG. 2c is another perspective view of the base from FIG. 2a.

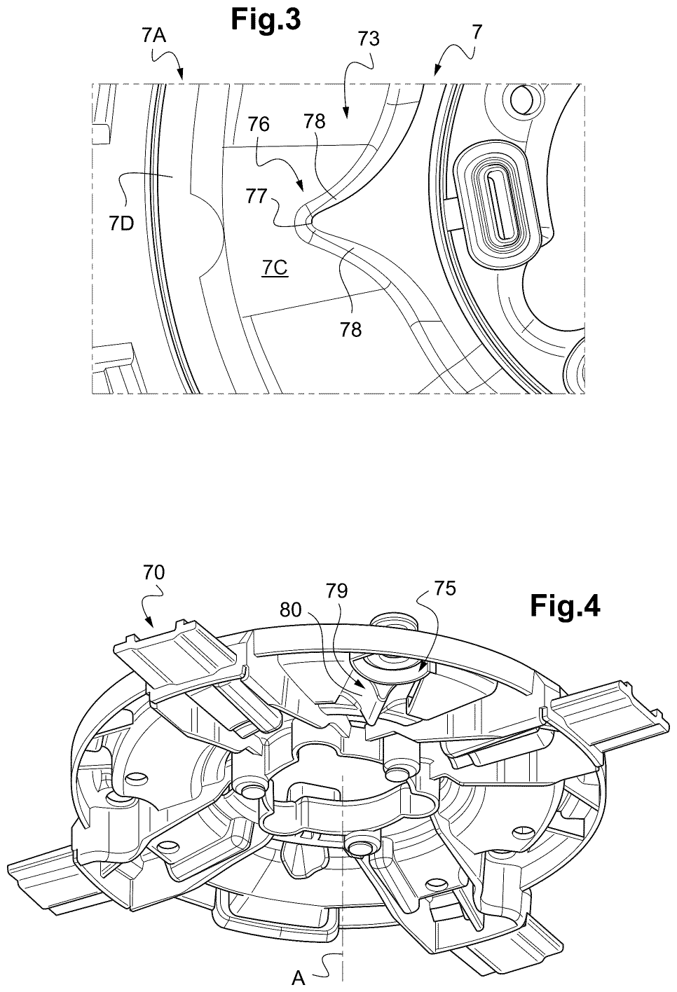

FIG. 3 is an enlarged view of a protrusion facing an air inlet formed in the base.

FIG. 4 is a perspective view of the base from below, showing a rib at an air outlet formed in the base.

In the figures, identical elements have the same reference numbers.

The following embodiments are examples. Although the description refers to one or more embodiments, this does not necessarily mean that each reference relates to the same embodiment, or that the features apply only to one embodiment. Individual features of different embodiments can also be combined or interchanged in order to create other embodiments.

In the description, certain elements can be given ordinal numbers, for example first element or second element. In this case, the ordinal number is simply to differentiate and denote elements that are similar but not identical. This ordinal numbering does not imply that one element takes priority over another and such numbering can easily be interchanged without departing from the scope of the present invention.

FIG. 1 illustrates a side view of a motorized fan unit 1, also known as a pulser, in particular for a heating, ventilation and/or air-conditioning system (not shown) for a vehicle.

Conventionally, such a system for a vehicle, in particular a motor vehicle, comprises at least one ventilation duct or circuit, and means for heating and/or means for cooling the air which is set in motion. The motorized fan unit 1 is arranged within the system so as to set the air in motion, circulating in the duct of the system, in order to be distributed in the passenger compartment of the vehicle. The motorized fan unit 1 is generally intended to be mounted on a casing of the system (not shown on the figures).

The motorized fan unit 1 (or ventilation device) comprises in particular a fan impeller 3, an electric motor 5, and a support 7 for the motor 5, hereinafter referred to as the motor support 7. The invention concerns in particular the motor support 7 which is described in greater detail below.

The fan impeller 3 is intended to be driven in rotation about a rotational axis A so as to set the air in motion. The fan impeller 3 may have a generally substantially cylindrical form comprising blades or vanes.

The motor 5 is intended to drive the fan impeller 3 in rotation. The motor may in particular be a brushless motor 5.

The motor 5 comprises a fixed stator part and a rotor (not shown on the figures), the rotor being movable relative to the stator part and suitable for driving the fan impeller 3. The rotor is for example an external rotor. The rotor may take the form of a cup fastened to a motor shaft. The fan impeller 3 may be fastened directly on the motor shaft. The motor 5 and the fan impeller 3 are for example coaxial.

The rotor and the stator part may carry electromagnetic elements, the interaction of which causes the movement of the rotor relative to the stator part, and the movement of the fan impeller 3. In particular, the rotor may comprise magnets, for example fastened to an inner face of the cup. The stator part may be internal, i.e. positioned inside the rotor. The stator part comprises a stator and for example stator windings. The magnets of the rotor may be positioned radially outside the stator windings. The term “radially” is used in relation to the rotational axis A.

Also, the motor 5 is intended to be controlled by a control module 13. The control module 13 generally comprises an electronic board (not visible on the figures) having a control circuit such as a printed circuit, and carrying a set of electronic components allowing control of the motor 5. The control module 13 may comprise a predetermined number of terminals (not shown), configured to be connected to the motor 5 in order to supply the stator windings for example. The control module 13 may also comprise at least one connector electrically connected to the electronic board, in particular a control signal for the control circuit, and/or for supplying energy for the electrical supply to the motor 5 when connected to a wiring harness, for example, of the vehicle. Thus, the stator windings can create a magnetic field which drives the rotation of the rotor and, as a result, of the fan impeller 3.

The motor support 7 may carry the control module 13 of the motor 5. In particular, the control module 13 may be carried by a support piece, which forms for example a heat sink 15 and is fastened to the motor support 7. The heat sink 15 is advantageously made of aluminum. For example, the heat sink 15 may have an indentation defining a slot for receiving the control module 13. The indentation may be surrounded by a protruding rim. Finally, a cover 17 may be fastened to the motor support 7, in particular on the heat sink 15, so as to cap the control module 13. As illustrated in FIG. 1, the control module 13 is concealed by this cover 17. It can be fastened by any appropriate means, for example, but non-limitingly, by screwing. The cover 17 thus defines, with the indentation in the heat sink 15, a housing for receiving the control module 13.

The motor support 7 is intended to allow the fastening of the motorized fan unit 1 to a structure in the vehicle, such as a casing of the system.

The motor support 7 comprises a base 70, visible on FIGS. 2a to 2c. The base 70 may have at least partly a form generated by revolution about an axis, coinciding for example with the rotational axis A of the fan impeller in the assembled state of the motorized fan unit. The base 70 may be centered around this axis A. The term “axis A” designates hereinafter both the axis of the base 70 and the rotational axis of the fan impeller/motor.

The base 70 may extend mainly along a plane normal to the axis A.

Furthermore, the base 70 may have a first face or upper face (visible on FIG. 2a) and a second face or lower face opposite the first face. The first face may be intended to carry the control module, whereas the second face may be intended to be arranged on the fan impeller side.

The base 70 comprises for example an internal structure 71 configured for fastening of the motor 5. For example, the internal structure 71 has an annular form.

The internal structure 71 may be in the center or substantially in the center of the motor support 7, in the center of the base 70. In the example illustrated, the internal structure 71 delimits a central orifice 72.

The base 70 may in particular comprise two rings, an inner ring 7A and an outer ring 7B.

At least one decoupling material, for example in the form of a decoupling ring 9, may be interposed between the inner ring 7A and the outer ring 7B. This may be an elastomer material connecting the rings 7A, 7B together. The elastomer material is polystyrene-b-poly(ethylene-butylene)-b-polystyrene or SEBS, for example. Alternatively, it may be silicone. The decoupling material makes it possible to limit the transmission of the vibrations generated by the motor and/or the fan impeller into the vehicle, and/or of external stresses to the motor and/or the fan impeller.

The internal structure 71 is for example a central structure of the inner ring 7A.

The two rings 7A, 7B may be coaxial. The outer ring 7B has a side wall, for example cylindrical. The inner ring 7A has a side wall, for example cylindrical, linking a bottom wall 7C and a front wall 7D which are opposite one another along the axis A. The front wall 7D defines for example an annular rim of the inner ring 7A on the side opposite the bottom wall 7C along the axis A of the base 70.

The inner ring 7A may be intended to be fastened to the motor, in particular to the stator. The heat sink 15 may be fastened to at least one of the rings, for example the inner ring 7A. In particular, the heat sink 15 may be arranged facing the bottom wall 7C of the inner ring 7A, being supported on the front wall 7D. The heat sink 15 may define a housing 16 mounted in the internal structure 71 of the base 70. The housing 16 is intended to receive an element of the motor and extends from a first side of the heat sink 15. The slot for receiving the control module is provided on a second side of the heat sink 15 opposite the first side and opposite the base 70.

The outer ring 7B may be intended to be fastened directly or indirectly to the structure in the vehicle, such as the casing of the system. In the example illustrated in FIG. 1, the motor support 7 comprises a peripheral air deflector 11 to which the outer ring is fastened. The base may be received in a cavity of such a deflector 11. The air deflector 11 may be intended to be fastened to the structure in the vehicle, such as the casing of the system. When the motor support 7 and the fan impeller 3 are assembled, the air deflector 11 forms an interface between the motor support 7 and the fan impeller 3. In operation of the motorized fan unit 1, the air deflector 71 makes it possible to deflect at least part of the air set in motion by the fan impeller 5 towards the control module 7 and/or the motor 5.

With reference again to FIGS. 2a to 2c, the base 70 also comprises at least one cooling channel 73. This cooling channel 73 is provided around the internal structure 71.

The cooling channel 73 may be provided in the thickness of the base 70, thus forming an indentation in the base 70, for example in the inner ring 7A.

An air flow F for cooling the motor and/or the control module is intended to circulate in the cooling channel 73. To this end, the cooling channel 73 has at least one air inlet 74 and at least one air outlet 75, between which the air flow F can circulate. The air inlet 74 and the air outlet 75 may be diametrically opposed.

The air inlet 74 may take the form of at least one opening provided in the side wall of the outer ring 7B.

The air outlet 75 may take the form of at least one opening provided in the base 70, for example in the bottom wall 7C. According to a particular embodiment, the base 70 comprises a material bridge 7′, facing and in particular above the air outlet 75 with reference to the orientation of FIG. 2a, which connects the internal structure 71 to the front wall 7D of the inner ring 7A.

The internal structure 71 may have a protrusion 76 arranged facing the air inlet 74. This protrusion 76 extends from the internal structure 71 in the direction of the air inlet 74. In particular, when the internal structure 71 has an annular form, the protrusion 76 may extend from an outer wall of the annular form. In particular, the protrusion 76 extends radially relative to the axis A.

The protrusion 76 may have two opposite flanks, such that the air flow F coming from the air inlet 74 is split into at least two parts intended to circulate in the cooling channel 73. Each part of the air flow F may follow a different flow circuit from the other part of the air flow F.

The protrusion 76 may have an end 77 which is rounded, for example, and arranged facing a median or substantially median zone of the air inlet 74. Thus the two parts of the air flow F may be in equal or substantially equal proportions.

The protrusion 76 may have an evolute form. For example, the protrusion 76 has a form tapering in the direction of the air inlet 74. The end 77 of the protrusion 76 is thus tapered relative to the remainder of the protrusion 76.

With reference also to FIG. 3, the protrusion 76 has for example two concave surfaces 78 extending on either side of the end 77 of the protrusion 76. The concavity of these surfaces 78 is oriented towards the cooling channel 73. In other words, the flanks of the protrusion 76 may be curved and rounded.

Each concave (or recessed) surface 78 may describe a circle arc of at least 5°. As a specific and non-limiting example, the concave surface 78 may extend over a distance of at least 10 mm.

Such concave surfaces 78 make it possible to reduce the speed of the incoming air flow F, and guide the air flow F towards the interior of the cooling channel 73 without creating turbulence; this facilitates the flowing of the parts of air flow F on either side of the protrusion 76.

In the example illustrated, the protrusion 76 defines in general a droplet form, or resembles the form of a droplet.

The cooling channel 73 has a depth along the axis A of the base 73 which advantageously decreases between the air inlet 74 and the air outlet 75. The depth of the cooling channel 73 decreases continuously for example.

In particular, the base 70 may define a bottom wall and a front wall which are opposite one another along the axis A of the base 70, delimiting the cooling channel 73. For example, these are the bottom wall 7C and the front wall 7D of the inner ring 7A of the base 70.

In this case, the depth or height between the bottom wall 7C and the front wall 7D varies, in particular decreases, between the air inlet 74 and the air outlet 75. The depth h1 at the air inlet 74 is greater than the depth h2 at the air outlet 75. The bottom wall 7C thus forms a plane which is inclined relative to the plane defined by the front wall 7D. This difference in depth creates a venturi effect and makes it possible to improve the flow behavior of the air flow F.

Also, the base 70 may comprise at least one rib 79, shown on FIG. 4. This rib 79 extends from a side of the base 70 opposite the cooling channel 73. The rib 79 may in particular extend from the material bridge connecting the internal structure to the front wall of the inner ring.

The rib 79 is arranged at least partly facing the air outlet 75. Thus the cooling channel opens at the rib 79. In particular, the rib 79 may pass through the middle or substantially through the middle of the air outlet 75, such that the cooling channel opens on either side of the rib 75.

The rib 79 extends for example in a main extent direction which is normal to the plane defined by the bottom wall of the inner ring. The rib 79 may extend mainly along axis A.

The rib 79 may have a tapering form. This form may in some cases be similar to the form of the above-described protrusion facing the air inlet. For example, the rib 79 may have two concave surfaces 80 extending on the sides and from an end, rounded for example, on the side opposite the material bridge. Such surfaces 80 act as surfaces guiding the flowing of the air flow F.

In the assembled state of the motorized fan unit, the rib 79 extends in particular towards the motor. The air flow leaving the cooling channel may thus be guided towards the motor and the impeller, i.e. downward with reference to the orientation of the elements in FIGS. 1 to 4, without creating turbulence.

Also, in operation, it has been found that turbulence zones occur during the flowing of the air flow in the cooling channel. With reference again to FIGS. 2a, 2b, the base 70 may have at least one assembly element 19, for example at least one boss, extending from the bottom wall 7C of the base 70. The boss or bosses is/are for example provided for assembly of the base 70 with another piece of the motor support 7, such as the heat sink 15. Such bosses may create at least some of the turbulence zones for the air flow F.

At least one orifice 21, 23 is advantageously provided in a wall of the base 70, for example the bottom wall 7C.

One or more orifices, referred to below as first orifices 21, are provided in such a way as to limit the turbulence. They are advantageously located as a function of the turbulence zones. The orifices 21 may be best placed at the center of the vortex, or at a distance of less than or equal to 5 mm from the center of the vortex.

For example, at least one first orifice 21 is provided close to the assembly element 19 such as the boss.

In the example illustrated, at least two first orifices 21 are provided around the assembly element 19. The first two orifices 21 may be arranged symmetrically on either side of the assembly element 19.

The assembly elements 19, such as the bosses, and the associated first orifices 21 may be situated on the outer periphery of the cooling channel 73, i.e. opposite the internal structure 71.

In addition or alternatively, at least one orifice 23 may be arranged in a wall of the base 70, for example the bottom wall 7C of the base 70, close to the air outlet 75. In order to distinguish this orifice from the above-described first orifices 21, this orifice is referred to below as second orifice 23. Such a second orifice 23 may in some cases be provided in the absence of first orifices 21. The second orifice 23 makes it possible to change and in particular reduce the speed of the air flow F.

In the example illustrated, at least two second orifices 23 are provided close to the air outlet 75. The two second orifices 23 may be arranged symmetrically on either side of the air outlet 75.

The second orifice or orifices 23 may be placed at maximum 20 mm from the air outlet 75. They may be placed on the outer/inner periphery of the cooling channel 73 or in the center in order to best assist with the guidance of the air flow F.

Thus the motor support 7, as described above, makes it possible to improve the overall cooling performance, in particular of the control module 13 and/or the motor 5.

In effect, the base 70 defines a specific air channel 73 for the cooling function, and the protrusion 76 makes it possible to split the air flow F intended to circulate in this channel. This protrusion 76 makes it possible to create turbulence and increase the speed of the air flow F. This may take place such that the parts of the incoming air flow F hit the outer edge delimiting the cooling channel 73 before returning to the middle and towards the interior.

Furthermore, the inclined bottom of the cooling channel 73 makes it possible to improve the flow behavior of the air flow F from the air inlet 74 towards the air outlet 75.

One or more first and/or second orifices 21, 23 provided in the bottom of the base 70 make it possible to limit the turbulence and/or slow down the air flow F.

Finally, the flanks of the rib 79 opposite the cooling channel 73 allow better guidance of the air flow F towards the motor 5.

1. A motor support for a motor for driving a fan impeller of a motorized fan unit for a heating, ventilation and/or air-conditioning system of a motor vehicle, the motor support comprising a base comprising:
an internal structure which is configured for fastening of the motor,
wherein the base defines a cooling channel around the internal structure, in which channel an air flow is intended to circulate for cooling the motor and/or a control module of the motor intended to be fastened to the motor support, the cooling channel having at least one air inlet and at least one air outlet,
wherein the internal structure has a protrusion which is arranged facing the air inlet,
wherein the protrusion extends from the internal structure towards the air inlet so as to divide the air flow which is intended to come from the air inlet and circulate in the cooling channel
wherein the base comprises at least one rib extending from a side of the base opposite the cooling channel and arranged at least partly facing the air outlet.

2. The motor support as claimed in claim 1, wherein the protrusion has a form which tapers in a direction of the air inlet.

3. The motor support as claimed in claim 2, wherein the protrusion has two concave surfaces extending on either side of an end of the protrusion.

4. The motor support as claimed in claim 1, wherein the base has a form generated by revolution about an axis, and the protrusion extends radially relative to the axis.

5. The motor support as claimed in claim 4, wherein the cooling channel has a depth, along the axis of the base, which decreases between the air inlet and the air outlet.

6. (canceled)

7. The motor support as claimed in claim 1, wherein at least one orifice is provided in a wall of the base.

8. The motor support as claimed in claim 7, wherein at least one orifice is arranged at a distance of less than or equal to 20 mm from the air outlet.

9. The motor support as claimed in claim 1, comprising a heat sink fastened to the base and extending facing the cooling channel, the heat sink comprising:
a housing extending from a first side of the heat sink, mounted in the internal structure of the base and configured to receive an element of the motor, and
on a second side opposite the first side, a slot configured to receive the control module.

10. (canceled)
